(19) United States
(12) Patent Application Publication
(10) Pub. No.: US 2015/0169550 A1
(43) Pub. Date: Jun. 18, 2015

(54) Translation Suggestion

(71) Applicant: LENOVO ENTERPRISE SOLUTIONS (SINGAPORE) PTE, LTD., SINGAPORE (SG)

(72) Inventors: SASA CVIJETIC, RALEIGH, NC (US); JAVIER A. FIGUEROA, MIRAMAR, FL (US); ADRIAN X. RODRIGUEZ, DURHAM, NC (US); FELICIA N. SOTO, RALEIGH, NC (US)

(21) Appl. No.: 14/108,511

(22) Filed: Dec. 17, 2013

(51) Int. Cl. G06F 17/28

(52) U.S. Cl. CPC G06F 17/289

(57) ABSTRACT

Translation suggestion includes: receiving, by a translation engine from a user, text representing one or more words in a source language; translating, by the translation engine, the one or more words to a target language; identifying, by the translation engine in dependence upon the translated words, a common phrase in the target language for suggestion to the user; and suggesting, by the translation engine, the common phrase to the user.

### BACKGROUND OF THE INVENTION

1. Field of the Invention

The field of the invention is data processing, or, more specifically, methods, apparatus, and products for translation suggestion.

2. Description Of Related Art

Auto-completion of text is utilized in many data processing environments. Translation of text from a source language to target language is also utilized in data processing environments. Systems that utilize translation, however, often do not include auto-completion abilities.

### SUMMARY OF THE INVENTION

Methods, apparatus, and products for translation suggestion are disclosed in this specification. Such translation may include receiving, by a translation engine from a user, text representing one or more words in a source language; translating, by the translation engine, the one or more words to a target language; identifying, by the translation engine in dependence upon the translated words, a common phrase in the target language for suggestion to the user; and suggesting, by the translation engine, the common phrase to the user. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for translation suggestion according to embodiments of the present invention.

FIG. 2 sets forth a flow chart illustrating an exemplary method for translation suggestion according to embodiments of the present invention.

FIG. 3 sets forth a flow chart illustrating an exemplary web browser GUI for a translation engine in the form of a search engine.

### DETAILED DESCRIPTION OF EXEMPLARY EMBODIMENTS

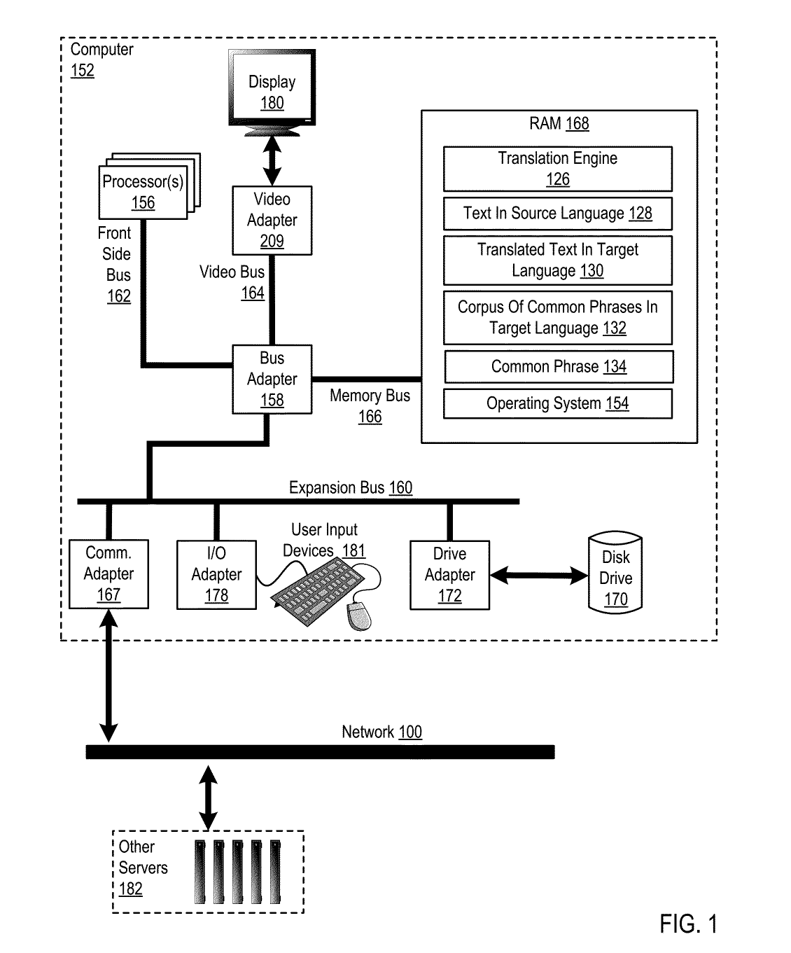

Exemplary methods, apparatus, and products for translation suggestion in accordance with the present invention are described with reference to the accompanying drawings, beginning with FIG. 1. FIG. 1 sets forth a network diagram of a system for translation suggestion according to embodiments of the present invention. The system of FIG. 1 includes automated computing machinery in the form of an exemplary computer (152) useful for translation suggestion according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is a translation engine (126), a module of computer program instructions that, when executed, cause the computer (152) of FIG. 1 to operate for translation suggestion according to embodiments of the present invention. To that end, the translation engine may receive text (128) representing one or more words in a source language. A source language as the term is used here refers to a language from which the translation engine will translate words and phrases into another language, referred to as a target language.

The translation engine (126) may then translate the one or more words to a target language (130). The translation engine may translate from a source language to a target language in a variety of ways including through the use of a corpus or dictionary data structure.

The translation engine (126) may then identify, in dependence upon the translated words (130), a common phrase (134) in the target language for suggestion to the user and suggest the common phrase (134) to the user. In some embodiments, the translation engine may identify a common phrase (134) in the target language by utilizing the translated words (130) as an index into a corpus (132) of common phrases in the target language.

In some embodiments the translation as well as the identification of common phrases may occur dynamically for each increment of received text. The term ‘increment of received text’ here refers to text received in a variety of ways: from keyboard keystrokes, from a speech-to-text engine, from virtual keyboard keystrokes or touch gestures encoded into text and the like. Prior art search engines utilize a ‘search as you type’ feature in which each keystroke results in a search function being executed and results are provided immediately. In this way, prior to completion of typing a full search query, it may be possible to provide a desired result to the final, full query. In a similar manner, the translation engine of the example of FIG. 1 may translate while a user types (or otherwise provides text to the translation engine), identify a common phrase in the target language and suggest the common phrase in the target language in a ‘translate and suggest as you type’ manner.

Also stored in RAM (168) is an operating system (154). Operating systems useful in computers configured for translation suggestion according to embodiments of the present invention include UNIX™, Linux™, Microsoft XP™, AIX™, IBM's i5/OS™, and others as will occur to those of skill in the art. The operating system (154) and the translation engine (126) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for translation suggestion according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for translation suggestion according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

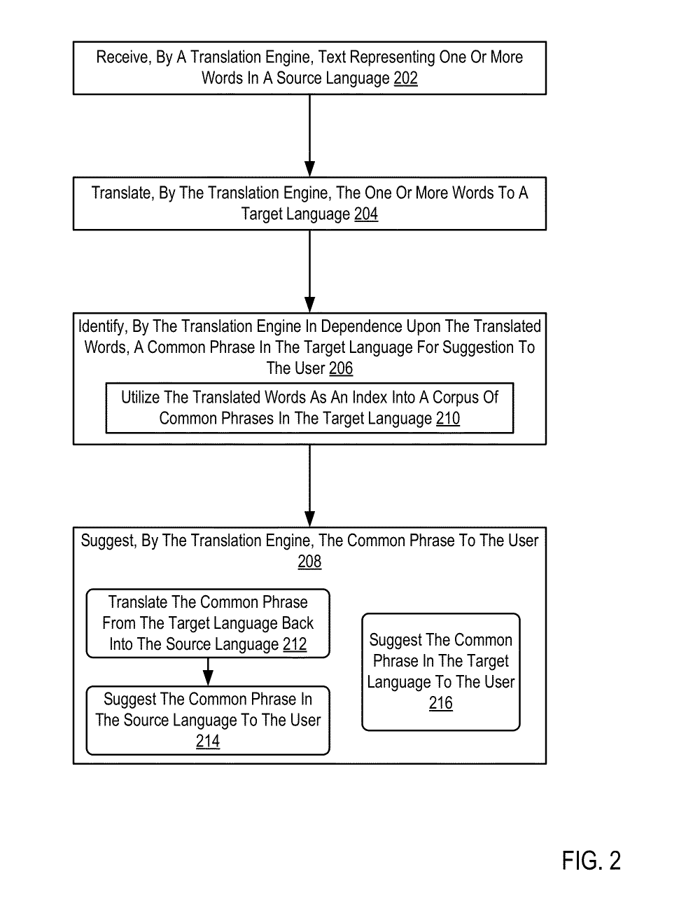

For further explanation, FIG. 2 sets forth a flow chart illustrating an exemplary method for translation suggestion according to embodiments of the present invention. The method of FIG. 2 includes receiving (202), by a translation engine, text representing one or more words in a source language. Receiving (202) text representing one or more words in a source language may be carried out in a variety of ways including for example, by receiving keyboard keystrokes, by receiving virtual keyboard keystrokes, by receiving text provided by a speech-to-text engine, by receiving touch-screen gestures representing text, and so on. That is, each increment of received text may include any one or more of: text received responsive to a keystroke on a keyboard; text received as an output of a speech-to-text engine; and text received responsive to user input on a touch screen.

The method of FIG. 2 also includes translating (204), by the translation engine, the one or more words to a target language. Translating (204) the one or more words to a target language may be carried out by looking up in a source-to-target language dictionary, each word or letter of a word for a translation. As noted above, the translation may be carried out in a ‘translate-as-you-type’ manner so that the translation occurs for each increment of text—a letter, a word, a set of words and so on.

The method of FIG. 2 also includes identifying (206), by the translation engine in dependence upon the translated words, a common phrase in the target language for suggestion to the user. In the method of FIG. 2, identifying (206) a common phrase in the target language for suggestion to the user may is carried out by utilizing (210) the translated words as an index into a corpus of common phrases in the target language. As mentioned above, the identification of the common phrase may occur dynamically, for each increment of received text. That is, the identification of a common phrase may occur for each translation which may occur immediately upon receipt of text and repeat for each received increment of text.

The method of FIG. 2 also includes suggesting (208), by the translation engine, the common phrase to the user. In the method of FIG. 2, suggesting (208) the common phrase to the user includes translating (212) the common phrase from the target language back into the source language and suggesting (214) the common phrase in the source language to the user. Suggesting (208) the common phrase may also be carried out by suggesting (216) the common phrase in the target language to the user.

Suggesting (216) the common phrase, in either case, may include displaying the common phrase in a graphical user interface (‘GUI’) presented to the user. As mentioned above, suggesting (208) a common phrase in the target language may be dynamic, for each increment of received text. That is, for each translation of text (which may occur dynamically for each increment of received text), the translation engine may identify and suggest a common phrase.

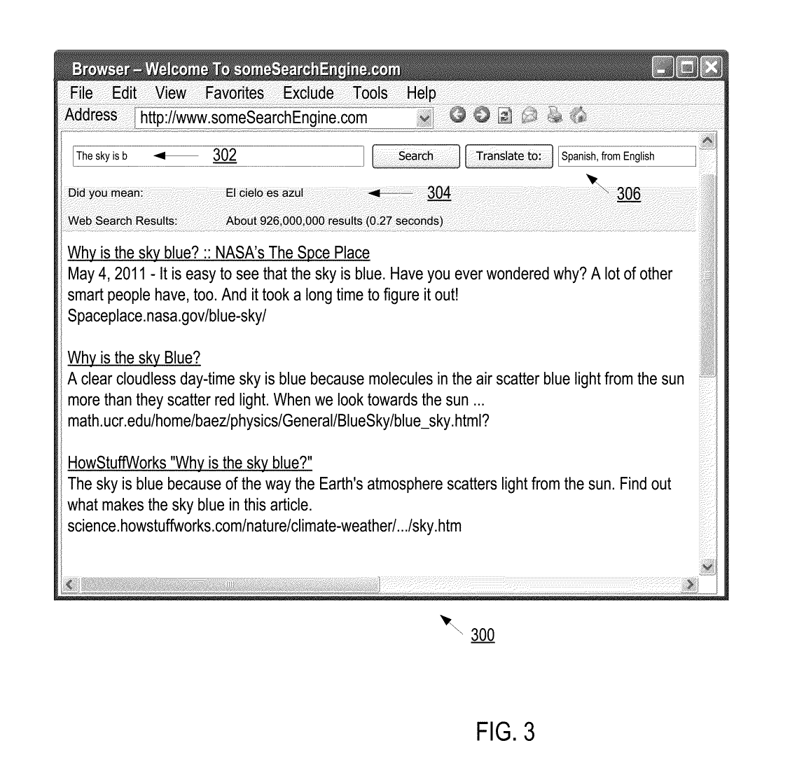

For further explanation, FIG. 3 sets forth a flow chart illustrating an exemplary web browser GUI for a translation engine in the form of a search engine. The example GUI (300) of FIG. 3 presents a search engine website. The website enables a user to select a source and target language for translation. In this example, a user has selected to translate text from English into Spanish.

The GUI (300) also presents a user an input field for receiving text. In the example of FIG. 3, the user has provided in the input field the text “The sky is b.” Here, the user has not completed the phrase “The sky is blue” for translation. The translation engine, however, has received the text, translated the text, “The sky is b,” into “el cielo es” and utilized the translated text to identify a common phrase in the target language. The common phrase, “el cielo es azul” translates, from Spanish into English, as “The sky is blue.” Having identified the common phrase, the translation engine also presents the common phrase (304), “el cielo es azul”. Further, the search engine utilizes the common phrase, translated back into the source language, English, as a search query and provides several search results.

The example GUI (300) depicts a snapshot of the translation engine after performing only a single translation, identification of a common phrase, and suggestion of the common phrase. Readers of skill in the art will recognize, however, that the translation engine may perform those steps for each increment of text (each letter in this example).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of translation suggestion, the method comprising:
receiving, by a translation engine from a user, text representing one or more words in a source language;
translating, by the translation engine, the one or more words to a target language;
identifying, by the translation engine in dependence upon the translated words, a common phrase in the target language for suggestion to the user; and
suggesting, by the translation engine, the common phrase to the user.

2. The method of claim 1 wherein, suggesting, by the translation engine, the common phrase to the user further comprises:
translating the common phrase from the target language back into the source language; and
suggesting the common phrase in the source language to the user.

3. The method of claim 1 wherein, suggesting, by the translation engine, the common phrase to the user further comprises:
suggesting the common phrase in the target language to the user.

4. The method of claim 1 wherein translating the one or more words to a target language, identifying a common phrase in the target language, and suggesting the common phrase to the user is carried out dynamically, for each increment of received text.

5. The method of claim 4 wherein each increment of received text comprises one of:
text received responsive to a keystroke on a keyboard;
text received as an output of a speech-to-text engine; and
text received responsive to user input on a touch screen.

6. The method of claim 1 wherein identifying, in dependence upon the translated words, a common phrase in the target language for suggestion to the user further comprises utilizing the translated words as an index into a corpus of common phrases in the target language.

7. An apparatus for translation suggestion, the apparatus comprising a computer processor, a computer memory operatively coupled to the computer processor, the computer memory having disposed within it computer program instructions that, when executed by the computer processor, cause the apparatus to carry out the steps of:
receiving, by a translation engine from a user, text representing one or more words in a source language;
translating, by the translation engine, the one or more words to a target language;
identifying, by the translation engine in dependence upon the translated words, a common phrase in the target language for suggestion to the user; and
suggesting, by the translation engine, the common phrase to the user.

8. The apparatus of claim 7 wherein, suggesting, by the translation engine, the common phrase to the user further comprises:
translating the common phrase from the target language back into the source language; and
suggesting the common phrase in the source language to the user.

9. The apparatus of claim 7 wherein, suggesting, by the translation engine, the common phrase to the user further comprises:
suggesting the common phrase in the target language to the user.

10. The apparatus of claim 7 wherein translating the one or more words to a target language, identifying a common phrase in the target language, and suggesting the common phrase to the user is carried out dynamically, for each increment of received text.

11. The apparatus of claim 10 wherein each increment of received text comprises one of:
text received responsive to a keystroke on a keyboard;
text received as an output of a speech-to-text engine; and
text received responsive to user input on a touch screen.

12. The apparatus of claim 7 wherein identifying, in dependence upon the translated words, a common phrase in the target language for suggestion to the user further comprises utilizing the translated words as an index into a corpus of common phrases in the target language.

13. A computer program product for translation suggestion, the computer program product disposed upon a computer readable medium, the computer program product comprising computer program instructions that, when executed, cause a computer to carry out the steps of:
receiving, by a translation engine from a user, text representing one or more words in a source language;
translating, by the translation engine, the one or more words to a target language;
identifying, by the translation engine in dependence upon the translated words, a common phrase in the target language for suggestion to the user; and
suggesting, by the translation engine, the common phrase to the user.

14. The computer program product of claim 13 wherein, suggesting, by the translation engine, the common phrase to the user further comprises:
translating the common phrase from the target language back into the source language; and
suggesting the common phrase in the source language to the user.

15. The computer program product of claim 13 wherein, suggesting, by the translation engine, the common phrase to the user further comprises:
suggesting the common phrase in the target language to the user.

16. The computer program product of claim 13 wherein translating the one or more words to a target language, identifying a common phrase in the target language, and suggesting the common phrase to the user is carried out dynamically, for each increment of received text.

17. The computer program product of claim 16 wherein each increment of received text comprises one of:
text received responsive to a keystroke on a keyboard;
text received as an output of a speech-to-text engine; and
text received responsive to user input on a touch screen.

18. The computer program product of claim 13 wherein identifying, in dependence upon the translated words, a common phrase in the target language for suggestion to the user further comprises utilizing the translated words as an index into a corpus of common phrases in the target language.

19. The computer program product of claim 13 wherein the computer readable medium comprises a signal medium.

20. The computer program product of claim 13 wherein the computer readable medium comprises a storage medium.
